(19) United States
(12) Patent Application Publication
(10) Pub. No.: US 2026/0086833 A1
(43) Pub. Date: Mar. 26, 2026

(54) AUTOMATED GUI DOCUMENTATION SYSTEM

(71) Applicant: ICT Inc., Seoul (KR)

(72) Inventor: Sung-Ryoul Lee, Seoul (KR)

(21) Appl. No.: 18/933,712

(22) Filed: Oct. 31, 2024

(30) Foreign Application Priority Data
Sep. 23, 2024 (KR) 10-2024-0128314

(51) Int. Cl. G06F 9/451; G06F 8/73; G06F 40/14; G06F 40/166

(52) U.S. Cl. CPC G06F 9/453; G06F 8/73; G06F 40/14; G06F 40/166

(57) ABSTRACT

Proposed is an automated GUI documentation system. The system includes a GUI capture part configured to capture a graphic user interface (GUI) screen of application software, and a GUI documentation part configured to analyze source code on the captured GUI screen and automatically generate a GUI manual on the basis of a result of analysis.

### CROSS-REFERENCE TO RELATED APPLICATION

This application claims priority to Korean Application No. 10-2024-0128314, filed Sep. 23, 2024, which is hereby incorporated by reference herein in its entirety, including any figures, tables, or drawings.

### BACKGROUND OF THE INVENTION

### Field of the Invention

The present disclosure relates to a user manual for application software. More particularly, the present disclosure relates to a manual for a graphic user interface of application software.

### Description of the Related Art

As is well known, a graphic user interface (GUI) refers to a user interface that uses graphic images to allow communication between computers and users. With the emergence of such GUIs, application software has been developed on the basis of GUIs, and users may use the application software without difficulty by referring to the documentation (manual) on how to use the GUI for each application software. However, the conventional GUI documentation process is done manually, which is time-consuming and costly and also has the problem that it is difficult to generate documentation with consistency, which is mainly as follows.
1. Reliance on manual work: Conventionally, manuals are written manually by professional technical writers. This takes a lot of time and effort and puts a lot of pressure on the authors.
2. Lack of consistency: Manual writing by hand may lead to inconsistencies in writing style or terminology over time between authors or even for the same author, which can make it difficult for end users to understand the manual.
3. Possibility of errors: Human authors are prone to making mistakes or omissions. These errors can reduce the quality of the manual and can be confusing to users.
4. Difficulty in updating and maintaining: If a product or service is constantly updated or changed, the manual should continue to be updated accordingly. Conventional methods make this update and maintenance task difficult.

The foregoing is intended merely to aid in the understanding of the background of the present disclosure, and is not intended to mean that the present disclosure falls within the purview of the related art that is already known to those skilled in the art.

### DOCUMENT OF RELATED ART

(Patent Document 1) Korean Patent Application Publication No. 10-2021-0026389 (published 10 Mar. 2021)

### SUMMARY OF THE INVENTION

The present disclosure is directed to providing a technical means for automatically generating a GUI manual for application software.

According to an aspect of the present disclosure, there is provided an automated GUI documentation system including: a GUI capture part configured to capture a graphic user interface (GUI) screen of application software; and a GUI documentation part configured to analyze source code on the captured GUI screen and automatically generate a GUI manual on the basis of a result of analysis.

The GUI capture part may be configured to capture the GUI screen of the application software selected through a user interface and store a GUI image, and allocate unique identifiers for respective GUI elements constituting the GUI screen and apply the unique identifiers to corresponding positions on the GUI image.

The GUI documentation part may be configured to analyze the source code by using a large language model (LLM), and generate the GUI manual containing explanations for the respective GUI elements on the basis of the GUI image in which the unique identifiers for the respective GUI elements are applied and the result of analysis of the source code.

According to another aspect of the present disclosure, there is provided an automated GUI documentation method including: capturing an image of a graphic user interface (GUI) of particular application software in a GUI capture step; and analyzing source code for the captured image of the GUI and documenting the GUI on the basis of a result of analysis in a GUI documentation step.

The present disclosure can generate a GUI manual automatically, which specifically has the following effects.

[Improved Productivity] With the present disclosure, a user can automatically generate a manual that was previously written manually. As a result, a user can significantly reduce the time and effort required to generate a manual, which improves overall work efficiency.

[Improved Quality] The content of a manual can be made more accurate and consistent. In addition, errors caused by human mistakes can be reduced, thereby greatly improving the quality of the manual.

[Increased Flexibility] A user can easily generate a manual in his or her preferred style and structure. In addition, the manual can be quickly modified or regenerated as the product or service updates. Accordingly, the time and cost required for the user to response to changes can be reduced.

[Improved User Experience] The present disclosure makes it easier for a user to understand and use a manual, thereby increasing user satisfaction and improving the experience of use of the product or service. In addition, the efficiency of the manual generation process can be greatly increased, and the quality of the manual can be improved and various effects that enhance the user experience can be provided. This contributes to improving the overall value of the product or service, and can help companies enhance their competitiveness.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a block diagram illustrating an automated GUI documentation system according to an embodiment;

FIG. 2 is a diagram illustrating an example of an original GUI image;

FIG. 3 is a diagram illustrating an example of a GUI image to which a unique identifier for each GUI element is applied;

FIG. 4 is a diagram illustrating an example of source code; and

FIGS. 5A to 5D are diagrams illustrating an example of a GUI manual automatically generated by FIG. 1.

### DETAILED DESCRIPTION OF THE INVENTION

The aforementioned and additional aspects of the present disclosure will become more apparent through exemplary embodiments described with reference to the accompanying drawings. Hereinafter, the present disclosure will be described in detail with reference to the embodiments so that those skilled in the art can easily understand and reproduce the embodiments.

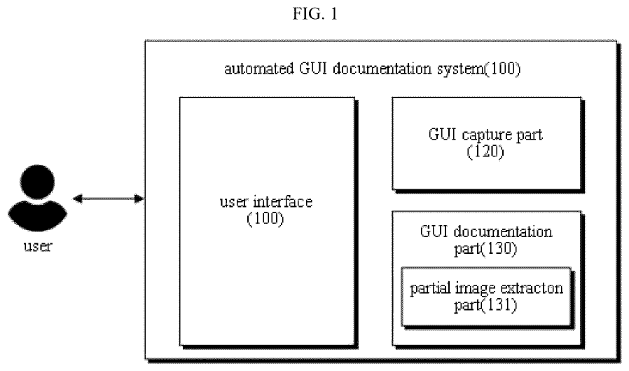

FIG. 1 is a block diagram illustrating an automated GUI documentation system according to an embodiment. The automated GUI documentation system (also referred to as a system for automatically generating a GUI manual) 100 is a computer system, and may include hardware resources, such as a processor, a memory, and a display, required for a computer in hardware although not shown in FIG. 1. Alternatively, the automated GUI documentation system 100 may refer only to a software system installed and running on a computer. As shown in FIG. 1, the automated GUI documentation system includes a GUI capture part 120 and a GUI documentation part 130. These are essential components for automatically generating a use manual for application software running on a computer, and may be realized in software and executed by at least one processor.

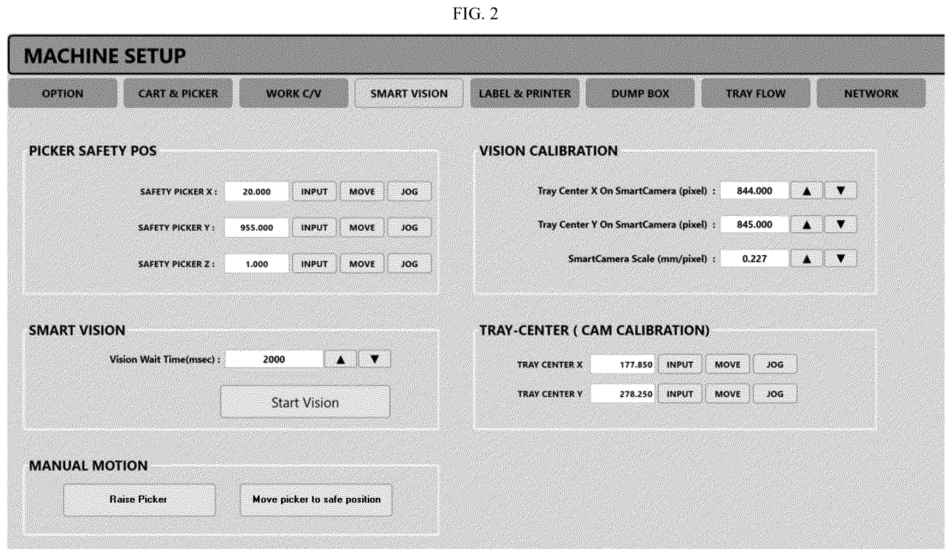

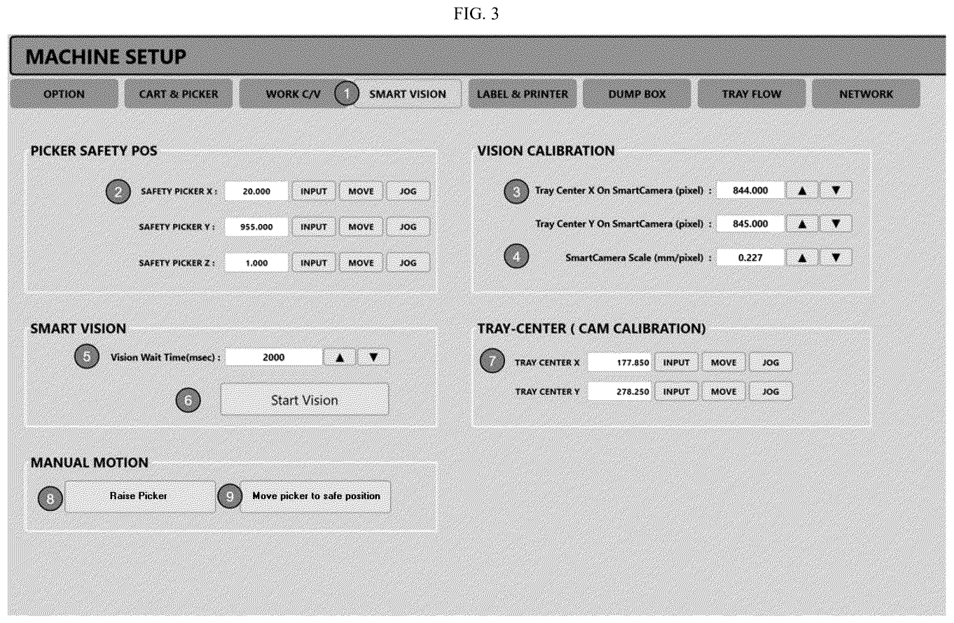

The GUI capture part 120 captures the execution screen (GUI screen) of the application software selected through the user interface 110 and stores the execution screen in the memory. For example, the GUI capture part 120 captures the GUI screen of the application software executed by a user and displayed on a display. The captured GUI screen is stored as an image file. To generate a complete manual, the GUI capture part 120 may capture all GUI screens of the application software. In one embodiment, the GUI capture part 120 automatically allocates a unique identifier (for example, number) for each of the GUI elements that constitute the GUI when the GUI screen is captured, and the unique identifiers are applied to the corresponding positions on the GUI image. That is, as shown in FIG. 3, for each GUI element, a unique identifier is applied to the captured original GUI image shown in FIG. 2. Herein, a GUI element to which a unique identifier is allocated refers to a GUI element that requires an explanation, that is, is the subject of a manual.

For example, the GUI capture part 120 uses a deep learning model trained with a large number of GUI training images, for division into GUI elements that are the subjects of a manual and GUI elements that are not, and allocates the unique identifiers to the GUI elements that are the subjects of the manual. As another example, the GUI capture part 120 allocates unique identifiers to GUI elements specified in person on a GUI image by a user. In addition, the unique identifiers may be stored with metadata of the GUI elements, and the metadata may include the positions, sizes, and types of the elements.

The GUI documentation part 130 analyzes the source code of the captured GUI screen and generates a GUI manual on the basis of the analysis result. In detail, the GUI documentation part 130 may analyze the source code of the captured GUI screen to identify the method (function) to which each GUI element is connected, and interpret the role and operation of the function on the basis of the structure and annotations of the code and then generate the explanation of each GUI element, and may finally generate a GUI manual by synthesizing the GUI image and the explanation of each GUI element.

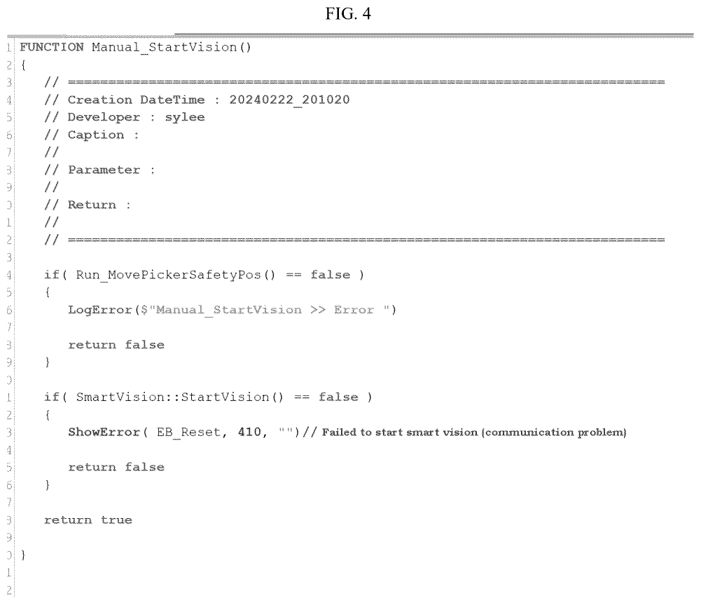

To this end, the GUI documentation part 130 may use a large language model (LLM) to perform analysis of source code and generation of the GUI manual. As the LLM, GPT-4, which is the fourth language model of the GPT series developed by OpenAI, may be used for example. Regarding this, an example of source code is shown in FIG. 4. The source code shown in FIG. 4 is for \textcircled{6} Start Vision shown in FIG. 3, and the explanation for this is generated through the GUI documentation part 130. In the meantime, the LLM may be used by the GUI capture part 120. For example, the original GUI image shown in FIG. 2 may be input to the LLM to identify the GUI elements through the LLM, and the GUI image to which unique identifiers are applied may be obtained as shown in FIG. 3.

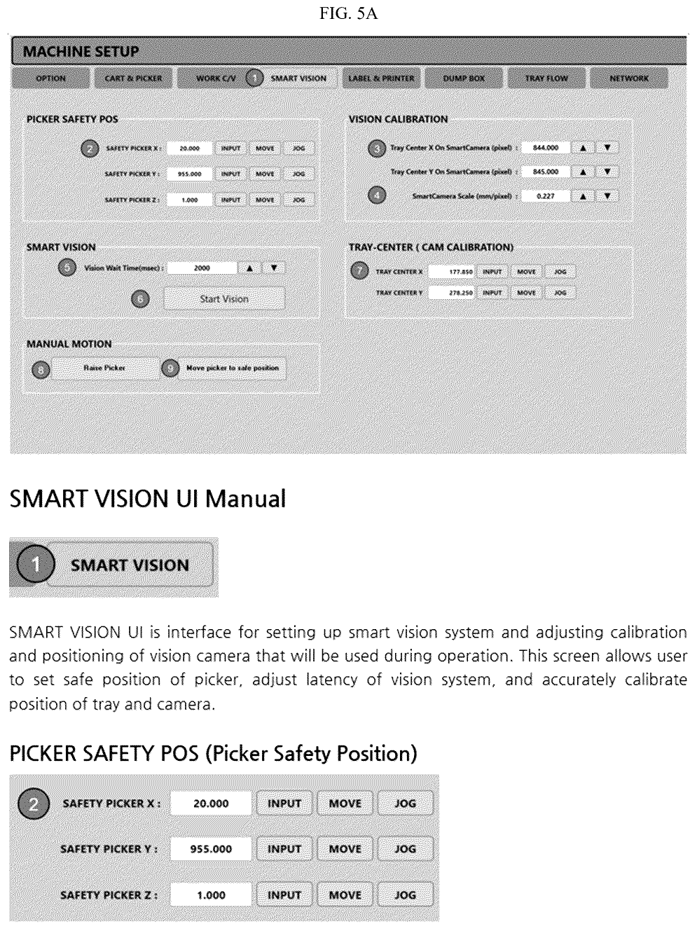

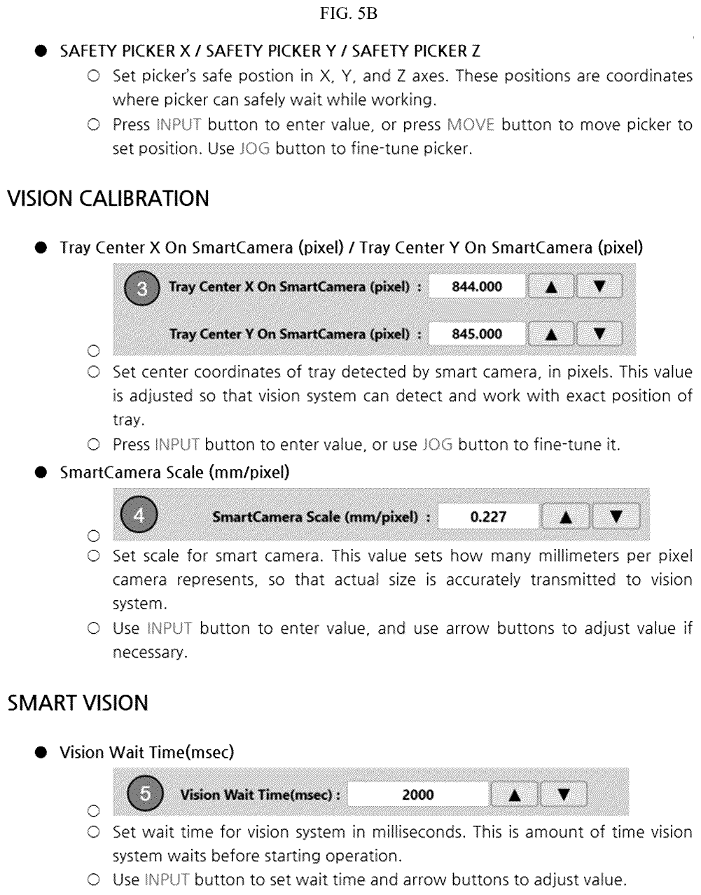

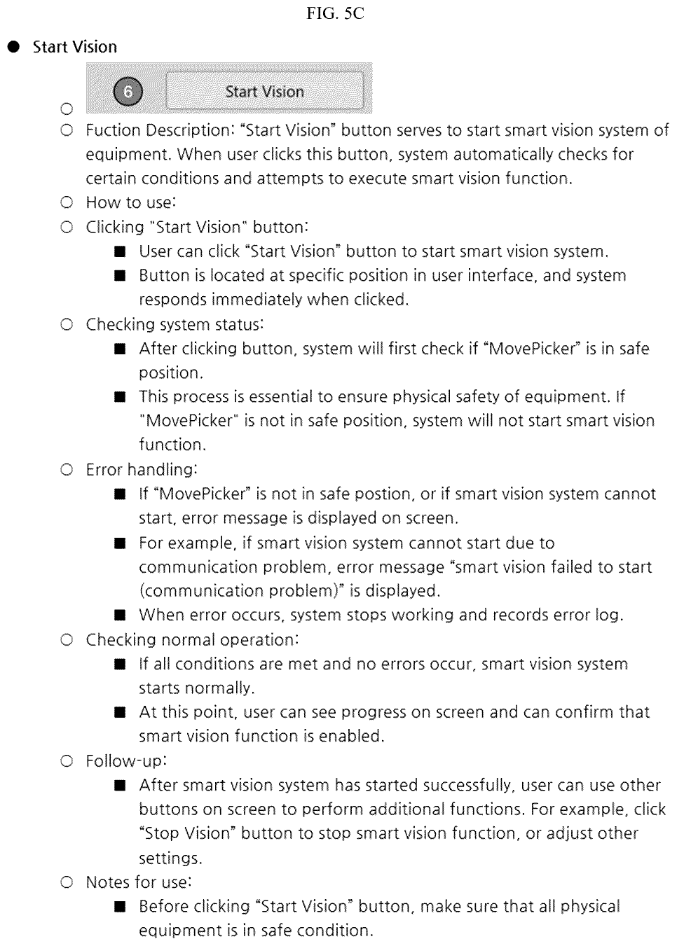

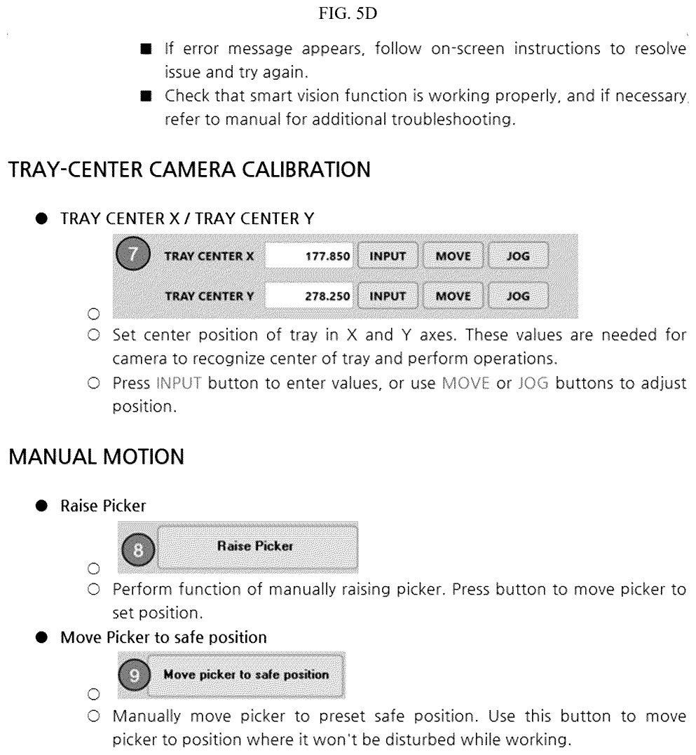

The GUI documentation part 130 may include a partial image extraction part 131. The partial image extraction part 131 extracts partial images, from a GUI image, to which unique identifiers are applied. That is, the partial image extraction part 131 extracts, from the GUI image shown in FIG. 3, each of the partial images that represent the GUI elements to which \textcircled{1} to \textcircled{9} unique identifiers are allocated. In addition, the GUI documentation part 130 generates a GUI manual that includes a GUI image and a partial image and an explanation for each GUI element. Regarding this, FIGS. 5A to 5D show a GUI manual generated by the GUI documentation part 130.

In the meantime, the user interface 110 may support various functions for GUI documentation, and may provide a user with a function of adjusting settings for GUI capture and source code analysis. For example, it may be set to capture only a particular screen or to perform only the documentation of a particular GUI element. In addition, the user interface 110 may provide a function of previewing or modifying a generated document. The user interface 110 may provide a function of displaying the document with an explanation number allocated to each GUI element, and allowing a user to directly jump to an explanation corresponding to an explanation number by clicking the explanation number. In addition, the user interface 110 may provide a function of storing and exporting documents in various formats, such as PDF, HTML, and DOCX.

In the meantime, an automated GUI documentation method includes a GUI capture step and a GUI documentation step performed subsequently thereto. Descriptions of the GUI capture step and the GUI documentation step are substantially identical to the above descriptions of the GUI capture part 120 and the GUI documentation part 130, so redundant descriptions are omitted.

The exemplary embodiments of the present disclosure have been particularly described. It will be understood by those skilled in the art that various changes in form are possible without departing from the essential features of the disclosure. Thus, the exemplary embodiments should be considered in a descriptive sense only and not for purposes of limitation. Therefore, the scope of the disclosure is defined not by the detailed description of the disclosure but by the following claims, and all differences within the scope will be construed as being included in the exemplary embodiments.

What is claimed is:

1. An automated GUI documentation system, comprising:
a GUI capture part configured to capture a graphic user interface (GUI) screen of application software; and
a GUI documentation part configured to analyze source code on the captured GUI screen and automatically generate a GUI manual on the basis of a result of analysis.

2. The automated GUI documentation system of claim 1, wherein the GUI capture part is configured to capture the GUI screen of the application software selected through a user interface and store a GUI image, and allocate unique identifiers for respective GUI elements constituting the GUI screen and apply the unique identifiers to corresponding positions on the GUI image.

3. The automated GUI documentation system of claim 2, wherein the GUI documentation part is configured to analyze the source code by using a large language model (LLM), and generate the GUI manual containing explanations for the respective GUI elements on the basis of the GUI image in which the unique identifiers for the respective GUI elements are applied and the result of analysis of the source code.

4. The automated GUI documentation system of claim 3, wherein the GUI documentation part is configured to extract partial images to which the unique identifiers are applied, from the GUI image, and generate the GUI manual containing the GUI image and the partial images and the explanations for the respective GUI elements.

5. An automated GUI documentation method, comprising:
capturing an image of a graphic user interface (GUI) of particular application software in a GUI capture step; and
analyzing source code for the captured image of the GUI and documenting the GUI on the basis of a result of analysis in a GUI documentation step.
